(19) United States
(12) Patent Application Publication
(10) Pub. No.: US 2006/0067366 A1
(43) Pub. Date: Mar. 30, 2006

(54) Time division multiplexed transport emulation using symbol encoded physical layer

(76) Inventors: Benjamin James Kerr, Northampton (GB); Peter Rowe, Hertfordshire (GB); Robert Gatward, Bedfordshire (GB)

Correspondence Address: BIRCH STEWART KOLASCH & BIRCH, PO BOX 747, FALLS CHURCH, VA, 22040-0747, US

(21) Appl. No.: 10/951,901

(22) Filed: Sep. 29, 2004

(51) Int. Cl. H04J 3/00

(52) U.S. Cl. 370/498; 370/475

(57) ABSTRACT

Embodiments of methods, apparatuses, and systems to transport Time Division Multiplexed (TDM) utilizing symbol encoded physical layer are disclosed. The embodiments of the invention provide a low cost solution to exchange data between TDM data elements while retaining guaranteed performance. A media access control layer generates framed data and the system guarantees delivery of the framed data to the designated destination within a fixed interval period of time.

### FIELD OF THE INVENTION

The field of the invention generally relates to interconnection technologies to transport data between data devices. In particular, the invention relates to transporting data between data devices, for example between private branch exchange elements, using symbol encoded physical layer.

### BACKGROUND OF THE INVENTION

In many circumstances, proprietary interconnection technologies are utilized to exchange data between data devices. For example, RS-485 type technology is used to transport Time Division Multiplexed (TDM) data in many present commercial practices. TDM data are exchanged, for example, between private branch exchange (PBX) equipments. RS-485 transport data across four (4) pairs of wires (8 conductors) as CLK, SYNC, DATA_IN and DATA_OUT.

The proprietary interconnection technologies, such as the traditional TDM PBX elements (e.g. line cards, switching elements or expansion boxes), are typically costly to produce and to maintain. Also, due to the proprietary nature, interoperability with other communication equipments becomes limited. In addition, physical distances between data elements are limited when using communication technologies like the RS-485.

Standard interconnection technologies are also utilized to exchange data between data devices, and these technologies provide the benefit of defined, standardized layers. For example, the Ethernet network, based on carrier sense multiple access with collision detection (CSMA/CD) standard, is widely used. Also Token Ring is widely used.

Because of the standardization, the equipments are less costly to produce and to maintain. Also, the interoperability is high. In addition, these technologies allow the transport distances to be large.

However, these standards do not guarantee delivery of data within a fixed periodic interval of time. Thus, there is a risk in utilizing such standardized networks to transport time critical data.

### SUMMARY OF THE INVENTION

The present invention is intended to address one or more of the disadvantages of the conventional systems to exchange communications data. Thus, according to an embodiment of the present invention, a TDM apparatus comprises a media access controller (MAC) layer device configured to generate a framed TDM data to be delivered to at least one destination TDM apparatus and a physical layer device configured to transmit the framed TDM data to a neighbor TDM apparatus over a transport medium. The framed TDM data is guaranteed to be delivered to the at least one destination TDM apparatus within a fixed periodic interval.

According to another embodiment of the present invention, a method to exchange TDM data for a TDM apparatus comprises generating a framed TDM data to be delivered to at least one destination TDM apparatus and transmitting to the framed TDM data to a neighbor TDM apparatus over a transport medium. The generated framed TDM data is guaranteed to be delivered to the at least one destination TDM apparatus within a fixed periodic interval.

According to yet another embodiment of the present invention, a system to exchange TDM data comprises a plurality of TDM apparatuses. Each of the plurality of TDM apparatuses includes a MAC device configured to generate a framed TDM data to be delivered to at least one destination TDM apparatus and a physical layer device configured to symbol encode and transmit the symbol encoded framed TDM data to a neighbor TDM apparatus over a transport medium. The system is such that the symbol encoded framed TDM data is guaranteed to be delivered to the at least one destination TDM apparatus within a fixed periodic interval.

### BRIEF DESCRIPTION OF THE DRAWINGS

Features of the present invention will become more fully understood to those skilled in the art from the detailed description given herein below with reference to the drawings, which are given by way of illustrations only and thus are not limitative of the invention, wherein:

FIG. 1 illustrates communication apparatuses connected to each other over a transport medium according to an embodiment of the present invention;

FIG. 2 illustrates an exemplary media access control frame format according to an embodiment of the present invention;

FIG. 3 illustrates an example of a data stream framed by the media access control layer according to an embodiment of the present invention;

FIG. 4 illustrates an example communication apparatuses where retransmission of framed TDM data occurs according to an embodiment of the present invention;

FIG. 5 illustrates steps of a method for generating and transmitting communication data according to an embodiment of the present invention;

FIG. 6 illustrates exemplary details of the framed data generating step of FIG. 5 according to an embodiment of the present invention;

FIGS. 7A and 7B illustrate a method of receiving and processing framed data according to an embodiment of the present invention; and

FIGS. 8, 9, and 10 illustrate various networking architectures of systems according to embodiments of the present invention.

### DETAILED DESCRIPTION

For simplicity and illustrative purposes, the principles of the present invention are described by referring mainly to exemplary embodiments thereof. The same reference numbers and symbols in different drawings identify the same or similar elements. Also, the following detailed description does not limit the invention. The scope of the invention is defined by the claims and equivalents thereof.

The expression “connects” or “communicates” as used herein refers to any connection, coupling, link or the like by which signals carried by one element are imparted to the “connecting element.” Such “communicating” devices are not necessarily directly connected to one another and may be separated by intermediate components and/or devices. Likewise, the expressions “connection”, “operative connection”, and “placed” as used herein are relative terms and do not necessarily require a direct physical connection.

In an embodiment of the present invention, an apparatus may exchange time critical information - video, voice, stock market quotes, etc.—with another similar apparatus. Voice quality is measured using a scale known as the “Mean Opinion Score” (MOS), which ranges from 1 (very poor, unintelligible) to 5 (perfect quality). For example, for a good quality voice transmission (MOS>4), using the standard ITU G.711 A-law/Mu-law codec, it is generally accepted that data bytes should be delivered to the destination within 125 microsecond intervals.

For videos, a full frame of data should be delivered ranging from every 1/20^{th} second to every 1/30^{th} second and even faster. Another example of time critical data is the information of various stock markets. In this environment, prices of stocks change continually and having the up to the second information is very valuable. Trades that can be delivered to the brokers with a guaranteed delivery time ensures the trade can be made against a known stock price.

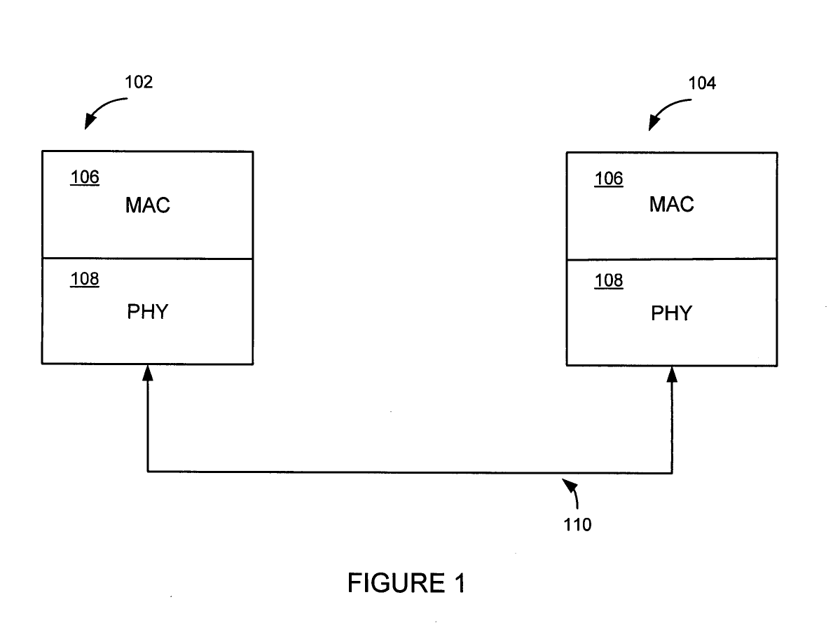

FIG. 1 is an embodiment of the present invention where communication apparatuses 102 and 104 communicate with each other over a transport medium 110. The apparatuses 102 and 104 may be TDM apparatuses and one can be considered to be a neighbor of the other. For simplicity, only two TDM apparatuses are illustrated. However, it is entirely possible, and indeed contemplated, that there are many more communication apparatuses connected with one another.

Also, for simplicity, the TDM apparatuses 102 and 104 are shown as being directly connected to each other through the transport medium 110. Such direct connection may be accomplished through a physical connection, such as a fiber optic line or a twisted pair line.

However, there may be one or more intervening devices between the TDM apparatuses 102 and 104 such as repeaters, amplifiers, and re-transmitters that allow the message traffic to flow between the TDM apparatuses 102 and 104. Thus, the transport medium 110 is best viewed as a logical connection. As will be shown later, the transport medium 110 may carry standardized physical layer message traffic.

The arrows entering into both TDM apparatuses 102 and 104 indicates that the transport medium 110 is bi-directional. Indeed, the transport medium 110 may be such that the communication between the TDM apparatuses 102 and 104 is full-duplex.

Each TDM apparatus 102, 104 may implement one or more layers of the ISO/IEC Model for Open Systems Interconnection (OSI). Again for simplicity, only two layers are shown—the Media Access Control (MAC) layer (which is a sublayer of OSI's data link layer) and the physical (PHY) layer. The MAC layer device 106 receives data from one or more MAC clients, frames the received data, and passes the framed data to the PHY layer device 108.

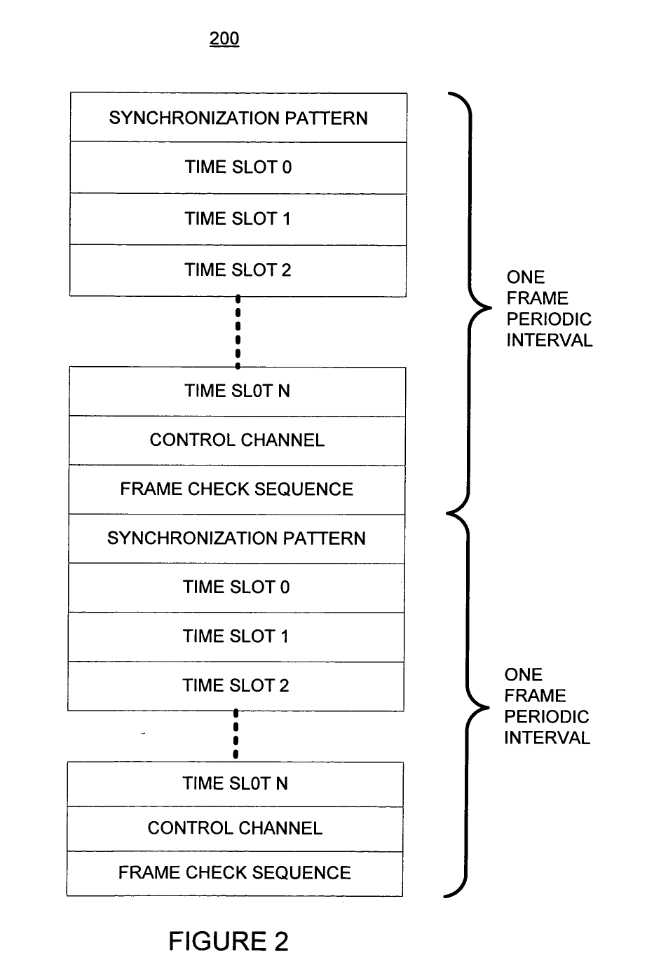

An exemplary MAC frame format 200 according to an embodiment of the present invention is illustrated in FIG. 2. Each frame may include a synchronization pattern, a plurality of time slots (time slots O to n), a control channel, and a frame check sequence.

The synchronization pattern may be a sequence that indicates a repetitive period of the MAC layer packet. It also provides a unique pattern to allow a bit synchronous receiver to locate and delineate a correct boundary in a sequence of bit stream. For example, the synchronization pattern may define the correct octet boundary.

Time slots may include time critical multiplexed payload data (for example, telephone speech samples, video data or stock prices). Each timeslot represents a unique telephone call, video stream or stock price.

Control channel may be a sequence used for conveying inter-equipment control messages, for example, assigning unique addresses to each apparatus, indicating error conditions, and indicating clock source reliability.

Frame Check Sequence may be a sequence calculated using common frame checksum techniques (For example: (Cyclic Redundancy Check) CRC-32 (4 octets), CRC-16 (2 octets) or (Byte Interleaved Parity) BIP-8 (1 octet) over the entire packet. The Frame check sequence may be used to provide indication of possible packet corruption due to bit-errors, and also allows the receiver to correctly identify and delineate the packet boundaries.

It is possible to transport multiple channels of information a single transport medium through a multiplexing technique. An example of multiplexing technique is time division multiplexing (TDM). This is a technique in which different pieces of data occupy a particular time slot in a message data stream.

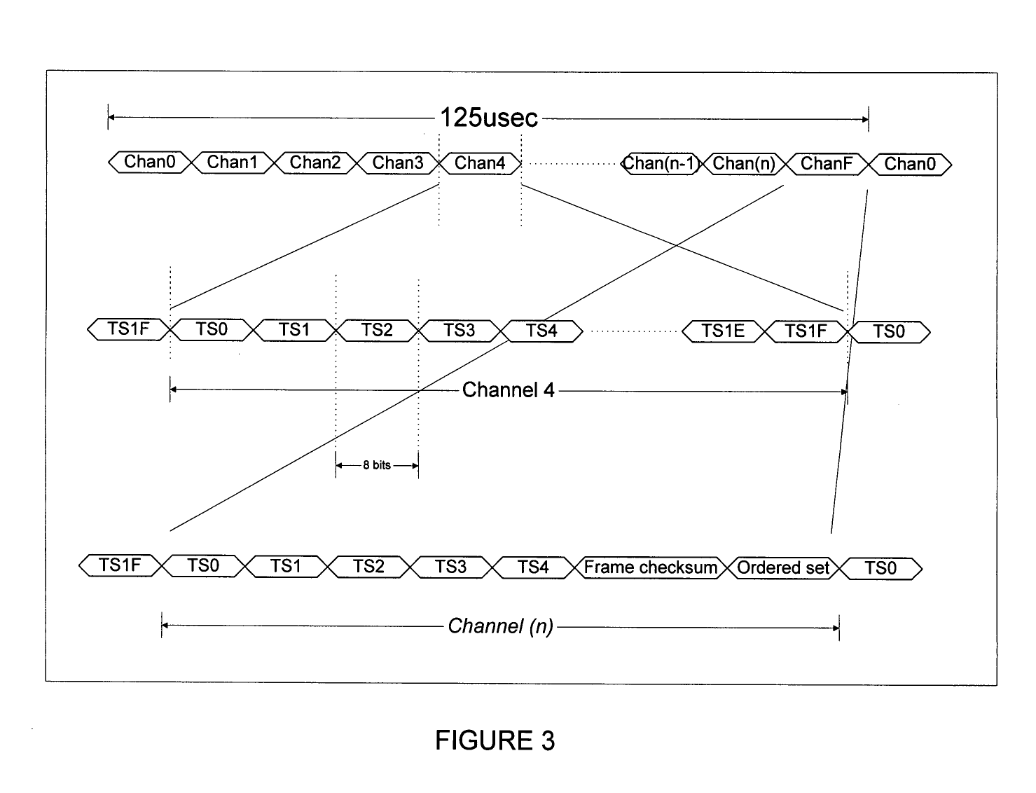

FIG. 3 illustrates an example of a data stream framed by the MAC layer device 106 according to an embodiment of the present invention. The framed data stream may include one or more channels. Data contained within each channel are destined for a particular destination apparatus, i.e. a particular TDM apparatus node in a network. Multiple channels may be destined for the same node. For example, channels 1 and 4 of FIGS. 3 may be destined to a particular TDM apparatus, which is different from a destination of channel 2.

In FIG. 3, n channels are transmitted within a fixed time interval—in this instance 125 microseconds (to transport voice data for example)—by the MAC layer device 106. It should be noted that the fixed time interval may be any value deemed appropriate for the type of data. Indeed, different frames transmitted by the same MAC layer device 106 may have different time interval associated with each packet.

Each channel may include one or more time slices (TS) of data, and each time slice may represent data for a particular communication instance within the node of the network. For example, if the node is a PBX equipment, each TS may represent data for telephone conversations being processed by the PBX equipment. In FIG. 3, channel 4 includes 32 time slices (TS0-TS1F). Thus, the PBX equipment may handling as many as 32 simultaneous telephone conversations. For the situation described in FIG. 3, the MAC framed data of FIG. 3 may be considered to be a framed TDM data.

More than one time slice may be associated with the same communication instance. For example, again referring to FIG. 3, time slices TS0 and TS1 may be associated with the same telephone conversation. Also, multiple time slices may be used to deliver higher data rate for those communication instances that require the higher rate. For example, video information for an application on a node may be delivered to the node using all or some of the time slices. In short, each time slice may represent a specific type of time critical data.

In FIG. 3, the data width of the time slices is shown to be a byte or an octet (8 bits). However, the time slices are not limited to this data width. The widths of the time slices may be set to any arbitrary value depending on the physical transport medium and the needs of applications.

It should be noted that the MAC frame format 200 in FIG. 2 may include timing information and destination information which are used to ensure that the data channels arrive at the proper destination within the fixed periodic interval set by the MAC layer device 106. Such timing and destination information may be included in the control channel.

The MAC layer device 106 may set the fixed periodic interval for each frame from a plurality of predetermined fixed periodic intervals. The MAC frame format 200 may include an interval code to indicate the particular fixed periodic interval set for the associated framed TDM data. As noted above, the framed TDM data such that the framed TDM data is guaranteed to be delivered to the designated destination within the fixed periodic interval of time. This significantly reduces the risk when transporting time critical data over the network.

The framed TDM data stream of FIG. 3 may be encoded by the PHY layer device 108 before being provided to the transport medium 110. The PHY layer device 108 may utilize standardized physical layer protocols that are widely available today. Examples of standardized physical layer protocols include the standards listed in the IEEE Standard 802.3 documentation. These include, but not limited to, the IEEE 100BASE-X, 100BASE-TX, 1000BASE-T, 1000BASE-X, 10GBASE-X and all variants (copper, fiber, etc.) thereof. Of course, there are other standardized physical layer protocols such as Fiber Channel (FC-1, FC-2, 10GFC, etc.), Serial Rapid-IO, PCI-Express, etc.

The PHY layer device 108 may symbol encode the framed TDM data. For example, every four bits of the MAC frame data may be translated to five bits (4B/5B transmission coding) by the PHY layer device 108. This is a form of dc-balanced encoding mechanism used to prevent too many consecutive ones or zeros from being transmitted and thereby allow common phase-locked loop techniques to be used to recover the original bit clock used to send the data. Other examples of symbol encoding include 8B/10B transmission coding (which is another form of dc-balanced encoding), 4D-PAM5 (data encoding using 5 voltage levels), and MLT-3 (data encoding using 3 voltage levels)—as used by 100-BASETX.

The PHY layer device 108 may symbol encode the framed TDM data from the MAC layer device 106 and transmit the symbol encoded framed TDM data to a neighbor TDM apparatus. For example, the PHY layer device 108 of the TDM apparatus 102 may transmit the symbol encoded framed TDM data to the neighbor TDM apparatus 104 over the transport medium 110.

The PHY layer device 108 of the TDM apparatus 104 may receive the symbol encoded framed TDM data from the TDM apparatus 102, decode the received symbol encoded framed TDM data, and provide the decoded framed TDM data to its corresponding MAC layer device 106. The decoded framed TDM data is the same framed TDM data from the MAC layer device 106 of the TDM apparatus 102. In other words, the decoded framed TDM data may include the interval code, at least one channel including at least one time slice, and destination information associated with each channel.

The MAC layer device 106 may examine the decoded framed TDM data to determine if one or more channels are destined for the corresponding TDM apparatus. I.e., the MAC layer device 106 of the apparatus 104 determines whether any channels of the decoded framed TDM data are destined for the TDM apparatus 104. If so, the MAC layer 106 proceeds to process the corresponding channel or channels.

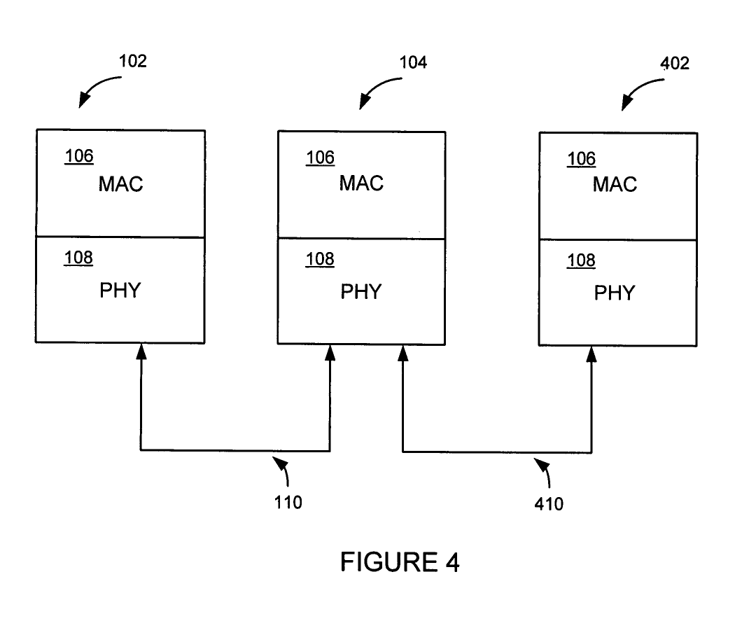

As implied above, the TDM apparatus 104 may not be the ultimate destination for some channels of the framed TDM data from the TDM apparatus 102. In this situation, the remaining channels should be delivered to their correct destinations. To accomplish this, the PHY layer device 108 may transmit the framed TDM data received from a first neighbor TDM apparatus to a second neighbor TDM apparatus. This is illustrated in FIG. 4.

In FIG. 4, the TDM apparatus 104 is illustrated to have TDM apparatus 102 as a first neighbor (connected through a first transport medium 110) and TDM apparatus 402 as a second neighbor (connect through a second transport medium 410). The PHY layer device 108 of the TDM apparatus 104 may retransmit to the framed TDM data from the first neighbor TDM apparatus 102 to the second neighbor TDM apparatus 402 as long as there are channels with destination other than itself—i.e. destinations other than TDM apparatus 104. Likewise, the TDM apparatus 402 may also retransmit the framed TDM data to yet another neighbor if the there are channels with destinations other than itself.

If the TDM apparatus 104 receives framed TDM data from the TDM apparatus 402, the retransmission, if necessary, would be to the TDM apparatus 102. It should be noted that communications through one or both of the transport mediums 110 and 410 may be full duplex.

To ensure that the framed TDM data is not transmitted and retransmitted forever, upon determining that there are channels destined for the current TDM apparatus, the MAC layer device 106 may reframe the TDM data received from the first neighbor TDM apparatus to mark the corresponding channel or channels as “consumed”. The PHY layer device 108 may then symbol encode the reframed TDM data prior to transmitting to the second neighbor TDM apparatus. Eventually, when all channels are consumed, the framed and reframed TDM data need not be retransmitted again.

As another way to ensure that a particular framed TDM data is not transmitted and retransmitted unnecessarily, each framed TDM data may include a frame identification, for example in the control channel. The MAC layer device 106 may then be able to recognize that a particular framed TDM data has been previously been received by the current TDM apparatus. When this occurs, the MAC layer device 106 and/or the PHY layer 108 may simply prevent retransmitting the particular framed TDM data.

It may be that a particular framed TDM data may have no channels destined for the current TDM apparatus. For example, again referring to FIG. 4, the framed TDM data from the TDM apparatus 102 may not have any channels with destination designated as the TDM apparatus 104. In this instance, since there will be no consumed channels, there would be no need for reframing the data and therefore, no need to symbol encode the reframed TDM data. The TDM apparatus 104, through the corresponding PHY layer 108, may simply retransmit the received symbol encoded framed TDM data from the first neighbor TDM apparatus 102 to the second neighbor TDM apparatus 402.

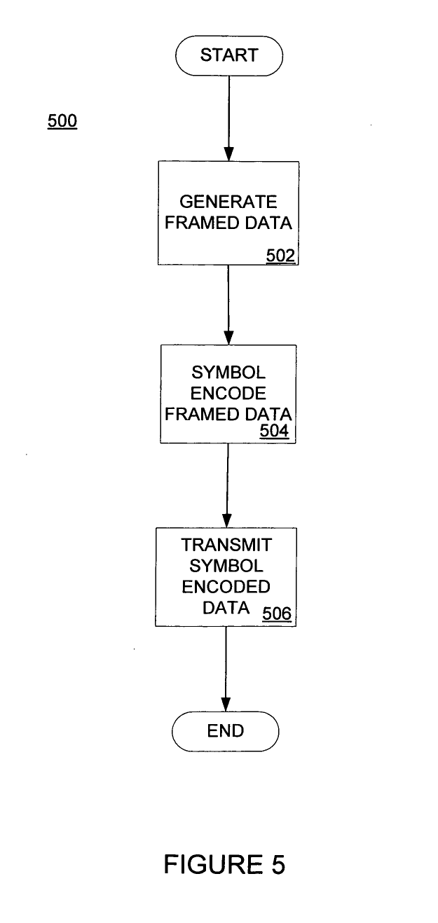

FIG. 5 illustrates steps of a method 500 for generating and transmitting communication data according to an embodiment of the present invention. The steps may be performed by the TDM apparatus 102, 104, 402 of FIG. 4 for example. As illustrated in FIG. 5, framed data may be generated (step 502). The framed data may be framed TDM data as discussed above. The framed TDM data may be symbol encoded (step 506) and then transmitted through a transport medium (step 506).

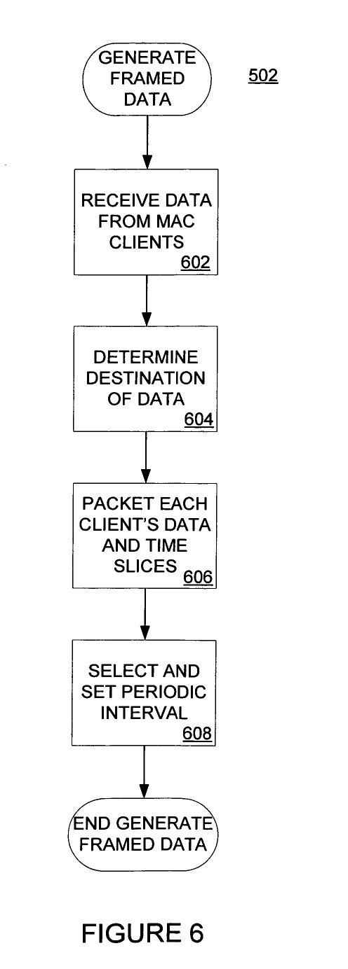

FIG. 6 illustrates exemplary details of the framed data generating step 502 according to an embodiment of the present invention. To generated the framed data, data from MAC clients may be received (step 602). For each data from the clients, destinations may be determined (step 604). The client's data may be packaged in time slices and framed accordingly (step 606). An appropriate fixed periodic interval may be set and coded into the framed data (step 608).

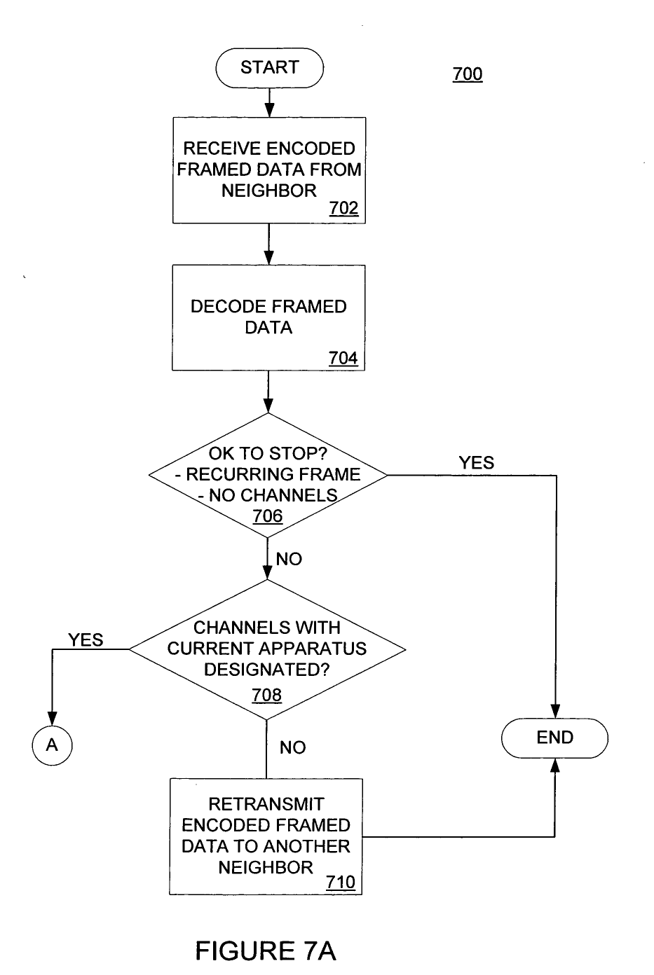

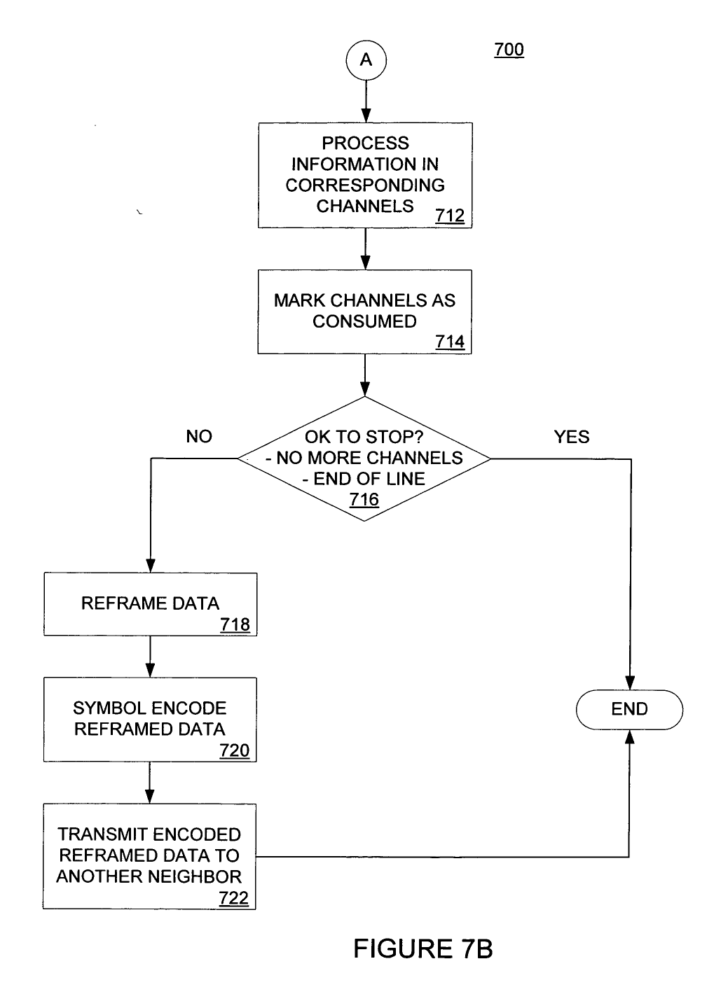

Just as a TDM apparatus may generate and transmit framed data, the same TDM apparatus may also receive and process framed data from other TDM apparatuses. FIGS. 7A and 7B illustrate this aspect. As illustrated, symbol encoded framed TDM data may be received (step 702) and decoded (step 704).

The decoded framed TDM data may be examined to determine if processing may stop (step 706). For example, the decoded framed TDM data may have been examined previously by the current TDM apparatus. This would indicate that the decoded framed TDM data has been examined and processed other TDM apparatuses of the network as well. In other words, the decoded framed TDM data has been processed before and there is no need to continue. Another reason for stopping the process is if all the channels have been consumed—i.e., there is no data left to process.

If it is determined to stop the process, then the method may end (YES branch from step 706). If it is determined that process should continue (NO branch from step 706), this indicates that there are still information channels that have not been processed (not consumed).

If there are still unconsumed channels, the framed TDM data may be examined to determine if the current TDM apparatus is designated to be the destination of one or more channels of the framed data (step 708). If not, then the received symbol encoded framed data may simply be retransmitted to another neighbor since there is no change to the data (step 710). If there are channel or channels designating the current TDM apparatus as the destination, then the corresponding channels may be processed accordingly (step 712) and the processed channels may be marked as consumed (step 714).

After the processing and marking the channels, the method once again may determine if the processing may stop (step 716). For example, all channels of the framed TDM data may have been consumed at this point, which makes further processing by any TDM apparatus unnecessary.

As another example, the current TDM apparatus may be designated as being “end of the line” where the current node simply does not retransmit any received framed data. This may be appropriate where a TDM apparatus is connected to only one other TDM apparatus. The processing may be halted if appropriate (YES branch from step 716).

If the processing of the framed data is to be continued (NO branch from step 716), then the framed TDM data, including the channels marked as consumed, may be reframed (step 718), symbol encoded (step 720), and transmitted to another neighbor (step 722).

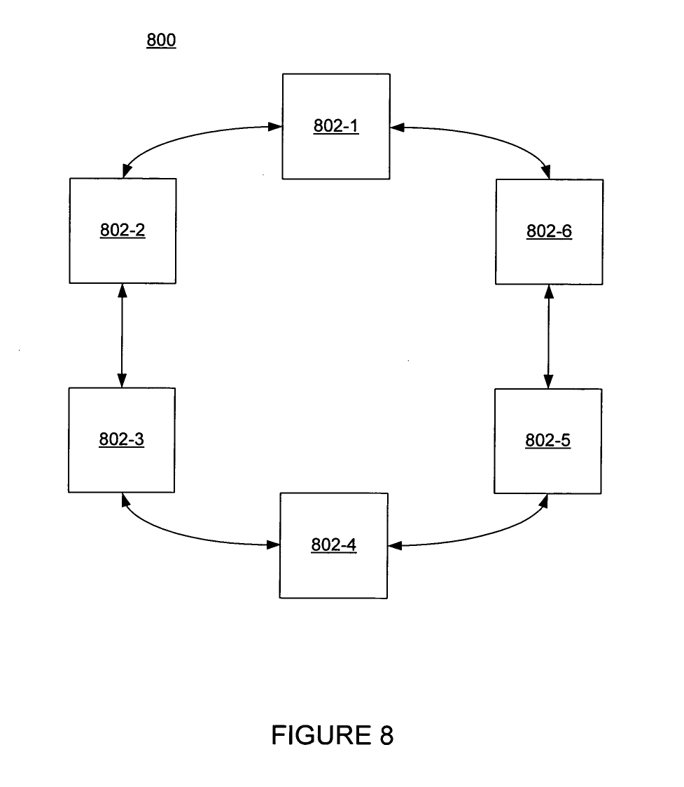

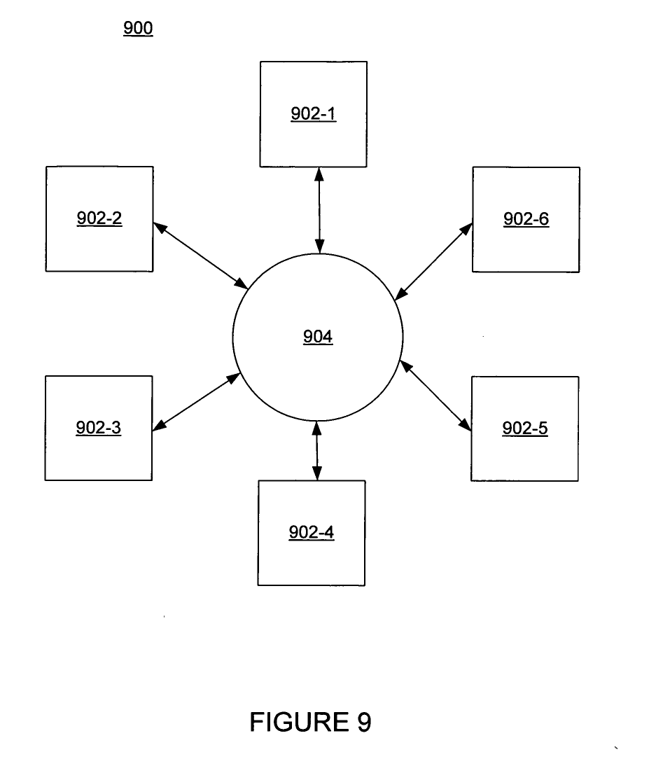

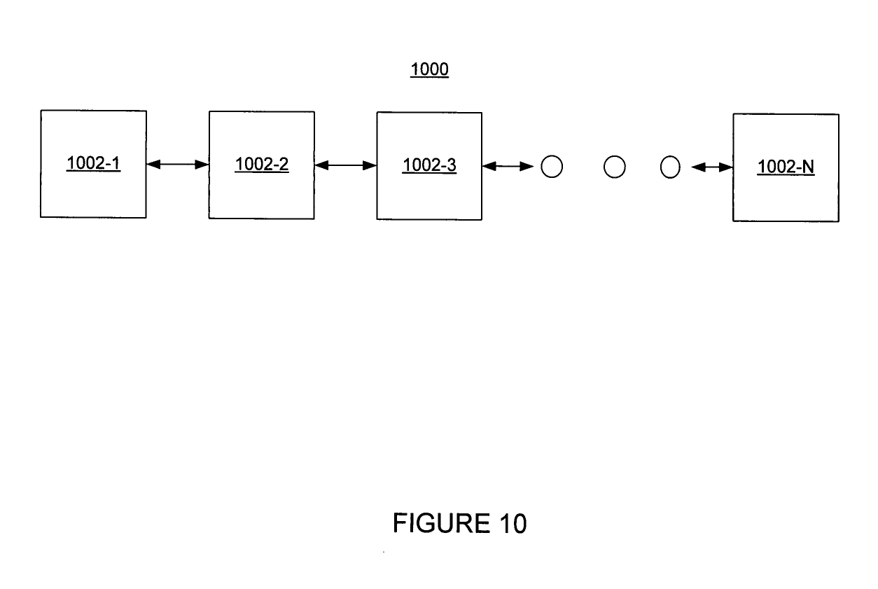

FIGS. 8, 9, and 10 illustrate possible networking architectures of system made up of multiple TDM apparatuses. FIG. 8 illustrates a ring architecture, FIG. 9 illustrates a star architecture using a central bridge, and FIG. 10 illustrates a chain architecture.

In FIG. 8, the system 800 includes six (6) TDM apparatuses, much like the TDM apparatuses 102, 104, and 402 of FIG. 4. While six TDM apparatuses 802-1 to 802-6 are illustrated, it is to be noted that the architecture is not so limited and may include an arbitrary number of TDM apparatuses. The bidirectional arrows between the TDM apparatuses indicate that the direction of communication is bidirectional between each neighboring TDM apparatuses. Further, the communication may be full duplex.

Any TDM apparatus may transmit framed TDM data to any other TDM apparatus, even if the two apparatuses do not directly communicate with each other. For example, the TDM apparatus 802-1 may transmit framed TDM data with one or more channels that are destined for the TDM apparatus 802-4. The framed data would first go to either the TDM apparatus 802-6 or to the TDM apparatus 802-2. The receiving TDM apparatus 802-2 or 802-6, after examining the framed TDM data, would forward the framed TDM data onward until the destination TDM apparatus 802-4 is reached.

Due to the structure of the MAC frame format and the functioning of the TDM apparatuses, the channels of the framed TDM data destined for the TDM apparatus 802-4 is guaranteed to reach the destination within the fixed interval period set by the originator TDM apparatus 802-1.

As described above, a framed TDM data may be prevented from circling forever as described above. For example, all channels may be consumed making further retransmission and processing unnecessary. Also the framed TDM data may complete a loop in the network and then detected as having been processed previously by one of the TDM apparatuses.

It is to be noted that the ring illustrated in FIG. 8 is a logical ring. Between any two neighboring TDM apparatuses, there may physically exist intervening devices such as signal repeaters, amplifiers and re-transmitters. However, the communication between any two neighboring TDM apparatuses is not interfered with.

FIG. 9 illustrates a system 900 of a star architecture utilizing a central bridge 904. The system 900 includes a plurality of TDM apparatuses 902-1 to 902-6. Again, the number of TDM apparatuses is not so limited. In this architecture, each TDM apparatuses 900-k, k=1 to n, is connected (again logically) to the central bridge 904. The communication between the TDM apparatus 900-k and the central bridge 904 may be bidirectional and also may be full duplex. Like the architecture of FIG. 8, between the TDM apparatus 902-k and the central bridge 904, intervening devices such as signal repeaters, amplifiers and re-transmitters may be included.

In this architecture, the originating TDM apparatus may simply transmit the framed TDM data to the central bridge 904, which then may examine the framed TDM data and route the data to the appropriate destination(s).

The central bridge 904 may be intelligent in its routing. For example, when an original framed TDM data from a TDM apparatus is received, the central bridge 904 may convert the original framed TDM data and transmit new framed TDM data to the appropriate destination(s).

As an illustration, assume that the TDM apparatus 902-1 transmits an original framed TDM data with channels destined for TDM apparatuses 902-2 and 902-5. The central bridge 904 may generate a new framed TDM data particularized for each destination TDM apparatus 902-2, 902-5. The particularized framed TDM data for the TDM apparatus 902-2 would only include channels originally destined for the TDM apparatus 902-2. Like wise, the TDM apparatus 902-5 would receive a particularized framed TDM data with channels only destined for itself.

The receiving TDM apparatuses would not retransmit the particularized framed TDM data since all channels would be consumed. Also, each TDM apparatus would be, by definition, is an end of the line TDM apparatus.

A less intelligent routing alternative is the following. The central bridge 904 may still examine the framed TDM data from the originator. However, instead of generating new framed TDM data particularized for each destination TDM apparatus, the central bridge 904 may simply retransmit exact copies of the original framed TDM data to the appropriate destination TDM apparatus. In other words, the central bridge 904 may multicast as necessary. Using the above-noted illustration, the central bridge 904 may multicast the original framed TDM data from the TDM apparatus 902-1 to both TDM apparatuses 902-2 and 902-5.

In this less intelligent routing, the destination TDM apparatuses would not retransmit the multicasted framed TDM data since they are both end of the line TDM apparatuses.

At the other extreme, a brute force routing may be employed by the central bridge 904. In this instance, any original framed TDM data received from each TDM apparatus may simply be broadcasted to all other TDM apparatuses. This ensures that the designated destination TDM apparatuses receive the framed TDM data. And again, the framed TDM data would not be retransmitted by the TDM apparatuses since all are end of the line apparatuses.

The choice of routing scheme employed in this star architecture may depend on particular circumstances. For example, the intelligent approach would be suitable in situations where the processing power of the central bridge is very high in relation to the bandwidth of the connections between the TDM apparatuses and the central bridge. In other words, intelligent routing is appropriate if the connections between the bridge and the TDM apparatuses is the bottleneck. Conversely, if the processing capability of the central bridge is the bottleneck, then it may be more efficient overall to utilize the multicast or broadcast routing.

FIG. 10 illustrates system 1000 of a chain architecture as noted above. As illustrated, the system 1000 includes a plurality of TDM apparatuses 1000-1 to 1000-N. The TDM apparatuses 1000-1 and N are the end of the line TDM apparatuses. Similar to the architectures of FIGS. 8 and 9, between adjacent TDM apparatuses, intervening devices such as signal repeaters, amplifiers and re-transmitters may be included. In this architecture, an originating TDM apparatus may simply send the framed TDM data in both directions with the exceptions of the apparatuses 1000-1 and 1000-N.

As a more intelligent alternative, each TDM apparatus may generate framed TDM data segregating the destinations so that each framed TDM data need be sent to only one side. For example, the TDM apparatus 1002-3 may generate a framed TDM data for destinations TDM apparatuses 1002-1 and 1002-2 and generate another framed TDM data for destinations 1002-4 to 1002-N.

It is to be noted that the architectures of the systems are not limited to the architectures of FIGS. 8, 9, and 10. It is fully contemplated that other types of network architectures are possible without departing from the scope of the invention. Also, while not shown, the particular architecture employed may be a combination of architectures.

While the invention has been described with reference to the exemplary embodiments thereof, it is to be understood that various modifications may be made to the described embodiments without departing from the spirit and scope of the invention thereof. The terms as descriptions used herein are set forth by way of illustration only and are not intended as limitations.

What is claimed is:

1. A time division multiplexed (TDM) apparatus, comprising:
a media access controller (MAC) layer device configured to generate a framed TDM data to be delivered to at least one destination TDM apparatus; and
a physical layer device configured to transmit the framed TDM data to a neighbor TDM apparatus over a transport medium,
wherein the framed TDM data is guaranteed to be delivered to the at least one destination TDM apparatus within a fixed periodic interval.

2. The apparatus of claim 1, wherein the physical layer device is configured to symbol encode the framed TDM data prior to transmitting to the neighbor TDM apparatus.

3. The apparatus of claim 2, wherein the physical layer device is configured to transmit the framed TDM data utilizing a standardized physical layer protocol.

4. The apparatus of claim 3, wherein the standardized physical layer protocol includes any physical layer protocol of IEEE 802.3 standard, Fiber Channel, Serial Rapid-IO, PCI-Express, and variants there of.

5. The apparatus of claim 2, wherein the MAC layer device is configured to set the fixed periodic interval among a plurality of predetermined fixed periodic intervals.

6. The apparatus of claim 5, wherein the MAC layer device is configured to frame an interval code into the framed TDM data indicating the fixed periodic interval that has been set.

7. The apparatus of claim 5, wherein the framed TDM data includes at least one channel and wherein the at least one channel has a particular destination.

8. The apparatus of claim 7, wherein the at least one channel includes at least one time slice and wherein the at least one time slice represents a specific type of time critical data.

9. The apparatus of claim 2, wherein the physical layer device is configured to receive a symbol encoded framed TDM data from the neighbor TDM apparatus, to decode the received symbol encoded framed TDM data, and to provide the decoded received framed TDM data to the MAC layer device, and wherein
the decoded received framed TDM data includes an interval code indicating the fixed periodic interval associated with the decoded received framed TDM data, at least one channel, and a destination associated with the at least one channel.

10. The apparatus of claim 9, wherein the MAC layer device is configured to process the at least one channel of the received framed TDM data if the destination of the at least one channel corresponds with the TDM apparatus.

11. The apparatus of claim 10, wherein
the neighbor TDM apparatus is a first neighbor TDM apparatus and the transport medium is a first transport medium, and
the physical layer device is configured to transmit the decoded received framed TDM data to a second neighbor TDM apparatus over a second transport medium.

12. The apparatus of claim 11, wherein
the MAC layer device is configured to determine that the decoded received framed TDM data includes at least one unconsumed channel with a destination that does not correspond with the TDM apparatus, and
the physical layer device is configured to transmit the decoded received framed TDM data to the second neighbor TDM apparatus upon such a determination.

13. The apparatus of claim 12, wherein
the MAC layer device is configured to reframe the decoded received framed TDM data to a reframed TDM data in the event that the destination of the at least one channel corresponds with the TDM apparatus such that the reframed TDM data indicates that the at least one channel has been consumed, and
the physical layer device is configured to transmit the reframed TDM data to the second neighbor TDM apparatus.

14. The apparatus of claim 13, wherein the physical layer device is configured to symbol encode the reframed TDM data prior to transmitting to the second neighbor TDM apparatus.

15. The apparatus of claim 12, wherein the physical layer device is configured to transmit the received symbol encoded framed TDM data to the second neighbor TDM apparatus upon determination from the MAC layer device that the destination of the at least one channel does not correspond with the TDM apparatus.

16. The apparatus of claim 1 1, wherein
the communication between the physical layer device and the first neighbor TDM apparatus is full duplex, or
the communication between the physical layer device and the second neighbor TDM apparatus is full duplex, or
both.

17. The apparatus of claim 2, wherein the communication between the physical layer device and the neighbor TDM apparatus is full duplex.

18. A method to exchange time division multiplexed (TDM) data for a TDM apparatus, the method comprising:
generating a framed TDM data to be delivered to at least one destination TDM apparatus; and
transmitting to the framed TDM data to a neighbor TDM apparatus over a transport medium,
wherein in the generating step, the framed TDM data is guaranteed to be delivered to the at least one destination TDM apparatus within a fixed periodic interval.

19. The method of claim 18, further comprising symbol encoding the framed TDM data prior to transmitting to the neighbor TDM apparatus.

20. The method of claim 19, wherein in the transmitting step, transmitting the framed TDM data utilizing a standardized physical layer protocol.

21. The method of claim 20, wherein the standardized physical layer protocol includes any physical layer protocol of IEEE 802.3, Fiber Channel, Serial Rapid-IO, PCI-Express, and variants there of.

22. The method of claim 19, wherein the generating step includes setting the fixed periodic interval among a plurality of predetermined fixed periodic intervals.

23. The method of claim 22, wherein the generating step includes framing an interval code into the framed TDM data indicating the fixed periodic interval that has been set.

24. The method of claim 22, wherein the framed TDM data includes at least one channel and wherein the at least one channel has a particular destination.

25. The method of claim 24, wherein the at least one channel includes at least one time slice and wherein the at least one time slice represents a specific type of time critical data.

26. The method of claim 19, further comprising:
receiving a symbol encoded framed TDM data from the neighbor TDM apparatus; and
decoding the received symbol encoded framed TDM data, wherein
the decoded received framed TDM data includes an interval code indicating the fixed periodic interval associated with the received framed TDM data, at least one channel, and a destination associated with the at least one channel.

27. The method of claim 26, further comprising processing the at least one channel of the received framed TDM data if the destination of the at least one channel corresponds with the TDM apparatus.

28. The method of claim 27, wherein the neighbor TDM apparatus is a first neighbor TDM apparatus and the transport medium is a transport physical medium, the method further comprising:
communicating with a second neighbor TDM apparatus over a second transport medium; and
transmitting the decoded received framed TDM data to the second neighbor TDM apparatus over a second transport medium.

29. The method of claim 28, further comprising:
determining whether or not the decoded received framed TDM data includes at least one unconsumed channel with a destination that does not correspond with the TDM apparatus; and
transmitting the decoded received framed TDM data to the second neighbor TDM apparatus upon such determining that the decoded received framed TDM data does include at least one unconsumed channel with a destination that does not correspond with the TDM apparatus.

30. The method of claim 29, wherein transmitting the decoded received framed TDM data step comprises:
reframing the decoded received framed TDM data to a reframed TDM data in the event that the destination of the at least one channel corresponds with the TDM apparatus such that the reframed TDM data indicates that the at least one channel has been consumed; and
transmitting the reframed TDM data to the second neighbor TDM apparatus.

31. The method of claim 30, further comprising symbol encoding the reframed TDM data prior to transmitting to the second neighbor TDM apparatus.

32. The method of claim 29, further comprising transmitting the received symbol encoded framed TDM data to the second neighbor TDM apparatus upon determination that the destination of the at least one channel does not correspond with the TDM apparatus.

33. The method of claim 28, wherein
the communication with the first neighbor TDM apparatus is full duplex, or
the communication with the second neighbor TDM apparatus is full duplex, or
both.

34. The method of claim 19, wherein the communication with the neighbor TDM apparatus is full duplex.

35. A system to exchange time division multiplexed (TDM) data, comprising:
a plurality of TDM apparatuses, wherein each TDM apparatus includes
a media access controller (MAC) device configured to generate a framed TDM data to be delivered to at least one destination TDM apparatus, and
a physical layer device configured to symbol encode and transmit the symbol encoded framed TDM data to a neighbor TDM apparatus over a transport medium,
wherein the symbol encoded framed TDM data is guaranteed to be delivered to the at least one destination TDM apparatus within a fixed periodic interval.

36. The system of claim 35, wherein the physical layer device is configured to transmit the framed TDM data utilizing a standardized physical layer protocol.

37. The system of claim 36, wherein the plurality of TDM apparatuses form one of a logical ring of TDM apparatuses.

38. The system of claim 37, wherein each communication connection between any two TDM apparatuses is full-duplex.

39. The system of claim 36, further comprising a central bridge, wherein each of the plurality of TDM apparatuses communicate with the central bridge and the central bridge is configured to route framed TDM data from the plurality of the TDM apparatuses.

40. The system of claim 39, further including a central bridge, wherein each TDM apparatus communicates in full-duplex mode with the central bridge.

41. The system of claim 39, wherein the framed TDM data is an original framed TDM data and the central bridge is configured to perform one of:
generate a particularized framed TDM data for each destination TDM apparatus designated in the original framed TDM data and transmitting each of the particularized framed TDM data to the corresponding destination TDM apparatus,
multicast to each destination TDM apparatus a copy of the original framed TDM data, and
broadcast to all TDM apparatuses a copy of the original framed TDM data.

42. The system of claim 36, wherein the plurality of TDM apparatuses form a logical chain of TDM apparatuses.

43. The system of claim 42, wherein each communication connection between any two TDM apparatuses is full-duplex.
